(19) United States
(12) Patent Application Publication
(10) Pub. No.: US 2025/0297475 A1
(43) Pub. Date: Sep. 25, 2025

(54) VIBRATION DAMPING DEVICE UNIT AND VIBRATION DAMPING DEVICE

(71) Applicant: Sumitomo Riko Comapny Limited, Aichi (JP)

(72) Inventors: Tomokazu Takada, Aichi (JP); Yuji Hirakida, Aichi (JP); Shinsuke Asai, Aichi (JP); Akira Nishimura, Tokyo (JP); Kazuto Takayama, Fukuoka (JP)

(73) Assignee: Sumitomo Riko Company Limited, Aichi (JP)

(21) Appl. No.: 19/231,562

(22) Filed: Jun. 9, 2025

Related U.S. Application Data
(63) Continuation of application No. PCT/JP2023/000358, filed on Jan. 11, 2023.

(51) Int. Cl. E04B 1/98

(52) U.S. Cl. CPC E04B 1/98

(57) ABSTRACT

A vibration damping device unit 10 is mounted to a building structure A to reduce vibration along a vertical direction for the building structure A. The vibration damping device has a support base 12 fixedly attached to a structural material a of the building structure A as a main vibration system. Mass members 20 are each elastically linked to the support base 12 by using a linking member 22, including a spring element and a damping element, thereby forming multiple auxiliary vibration systems 14. A tuned mass damper (TMD) is formed. The tuned mass damper has multiple natural frequencies in a vertical direction resulting from the auxiliary vibration systems 14.

### CROSS-REFERENCE TO RELATED APPLICATION

This application is a continuation of PCT International Application No. PCT/JP2023/000358, filed on Jan. 11, 2023. The above application is hereby expressly incorporated by reference, in its entirety, into the present application.

### BACKGROUND

### Technical Field

The disclosure relates to a vibration damping device unit that reduces vibration in a vertical direction for a building structure, and a vibration damping device suitably used in the vibration damping device unit.

### Description of Related Art

Conventionally, as a vibration damping device that reduces vibration in the upper-lower direction (vertical direction) occurring in a building structure, as described in Japanese Patent Application Laid-Open Publication No. 2017-198228 (Patent Document 1), it is known to configure an auxiliary vibration system with respect to a building structure as a main vibration system by supporting a mass body on the building structure by using a linking member. Such a vibration damping device forms a tuned mass damper (TMD) by tuning the natural frequency of the auxiliary vibration system to a frequency domain of the vertical vibration that becomes an issue for the building structure.

### PRIOR ART DOCUMENT(S)

### Patent Document(s)

Patent Document 1: Japanese Patent Application Laid-Open Publication No. 2017-198228

Meanwhile, the excitation force of the vibration in the upper-lower direction that becomes an issue for a building structure includes walking vibration and mechanical vibration exerted from the inside of the building structure, as well as earthquake vibration and traffic vibration exerted from the outside of the building structure, and the vibration transmission paths to the problematic vibration sites are diverse. Additionally, the vibration modes of various structural materials forming the vibration transmission path are also diverse, and the natural frequencies of various structural materials differ, causing vertical direction vibration to occur with complexly coupled vibration modes. Therefore, by merely directly mounting a single auxiliary vibration system to a specific part of the building structure as described in Patent Document 1, it is difficult to obtain a sufficient vibration damping effect against the vibration in the upper-lower direction.

The disclosure provides a vibration damping device unit with a novel structure that can efficiently exert a vibration damping effect with respect to the vibration in the upper-lower direction that becomes problematic for a building structure, and to provide a vibration damping device suitably used in the vibration damping device unit.

The following describes exemplary embodiments for understanding the disclosure, but the embodiments described below are illustratively described and can be adopted and appropriately combined with each other, and multiple components described in each embodiment can also be recognized and adopted independently as much as possible, and can be combined with any component described in another embodiment as appropriate. Accordingly, in the disclosure, various alternative embodiments can be realized without being limited to the embodiments described below.

### SUMMARY

A first aspect provides a vibration damping device unit, mounted to a building structure to reduce vibration along a vertical direction for the building structure. The vibration damping device has a support base fixedly attached to a structural material of the building structure as a main vibration system. Multiple mass members are each elastically linked to the support base by using a linking member including a spring element and a damping element, thereby forming multiple auxiliary vibration systems. A tuned mass damper (TMD) is formed. The tuned mass damper has multiple natural frequencies in a vertical direction resulting from the auxiliary vibration systems.

### BRIEF DESCRIPTION OF THE DRAWINGS

FIG. 1 is a plan view showing a vibration damping device unit as a first embodiment of the disclosure.

FIG. 2 is a front view of the vibration damping device unit shown in FIG. 1.

FIG. 3 is an enlarged longitudinal cross-sectional view showing a linking member forming the vibration damping device unit of FIG. 1, corresponding to a cross-section III-III of FIG. 4.

FIG. 4 is a plan view of the linking member shown in FIG. 3.

FIG. 5 is a front view of a metal coil spring forming the linking member shown in FIG. 3.

FIG. 6 is a front view and a longitudinal cross-sectional view of a linking member forming a vibration damping device unit as a second embodiment of the disclosure.

FIG. 7 is a plan view of a linking member forming a vibration damping device unit as a third embodiment of the disclosure.

### DESCRIPTION OF THE EMBODIMENTS

A first aspect provides a vibration damping device unit, mounted to a building structure to reduce vibration along a vertical direction for the building structure. The vibration damping device has a support base fixedly attached to a structural material of the building structure as a main vibration system. Multiple mass members are each elastically linked to the support base by using a linking member including a spring element and a damping element, thereby forming multiple auxiliary vibration systems. A tuned mass damper (TMD) is formed. The tuned mass damper has multiple natural frequencies in a vertical direction resulting from the auxiliary vibration systems.

According to the vibration damping device configured in accordance with the aspect, since multiple auxiliary vibration systems with different natural frequencies are provided, an effective vibration damping effect is exerted with respect to vertical vibration over a wide frequency domain as a whole. Therefore, it becomes possible to stably exert an effective vibration damping effect even with respect to vertical vibration having complexly coupled vibration modes.

Moreover, since the auxiliary vibration systems are integrated into a unit structure by the support base, by linking the support base to a structural material with large resonance energy on the vibration transmission path, for example, it becomes possible to directly exert the vibration damping effect by using the auxiliary vibration systems on the specific structural material.

In addition, since the shape and the size of the support base can be set with high flexibility, it becomes possible to set an installation space for mass members, etc., at a location away from the structural material where the vibration damping effect by the auxiliary vibration systems is to be exerted, and the design flexibility is also improved. Furthermore, since multiple auxiliary vibration systems can be supported on the support base while securing the stability of the supporting surface, regardless of the shape or the structure of the mounting site of the vibration damping device unit on the structural material, it becomes possible to stably mount to the target structural material in a horizontal state.

According to a second aspect, in the vibration damping device unit according to the first aspect, the mass member is supported by the linking members, each of the linking members is arranged as a composite structure in which multiple elastic materials of different material properties are adhered to each other, each of the elastic materials forming the linking member has a length dimension in an upper-lower direction able to link the mass member to the support base, and the mass member is directly and elastically supported on the support base by using the elastic materials forming the linking member.

According to the vibration damping device unit configured in accordance with the aspect, each mass member can be supported by the linking members at multiple locations, realizing stable support of the mass member by the linking members.

In addition, with the mass member being directly supported by multiple elastic materials of different materials, such as a metal spring and a rubber spring, the spring properties and the damping properties in the auxiliary vibration system can be set with high flexibility.

According to a third aspect, in the vibration damping device unit according to the second aspect, the elastic materials forming the linking member include a metal coil spring and an elastomer, the elastomer is adhered to a spring wire of the metal coil spring to cover an entire surface of the spring wire, and in the metal coil spring, pitches of adjacent spring wires in the vertical direction are linked by the elastomer.

According to the vibration damping device unit configured in accordance with the aspect, soft spring properties can be realized with excellent durability by the metal coil spring, while vibration damping effects can also be obtained by the elastomer. In addition, by covering the surface of the metal coil spring with the elastomer, chattering vibration that occurs during elastic deformation in a resonant state of the metal coil spring is suppressed by the damping effect of the elastomer.

In addition, a large adhesion area between the surface of the spring wire of the metal coil spring and the elastomer is secured, and the adhesion strength between the spring wire and the elastomer is increased. Therefore, the elastomer is prevented from being peeled off from the metal coil spring, effectively causing the elastomer to deform in accordance with the metal coil spring, and effectively obtaining the damping effect of the elastomer. With the surface of the metal coil spring covered by the elastomer, the durability through rust prevention of the metal coil spring can also be improved.

By having the elastomer arranged to elastically link adjacent spring wires in the spring axial direction of the metal coil spring, local bending deformation of the elastomer is prevented during the compression deformation of the metal coil spring. In addition, since the elastomer has high deformation conformability to the deformation of the metal coil spring, the damping effect of the elastomer can be efficiently exhibited. Additionally, since the mass member is directly supported by both the metal coil spring and the elastomer, the shared support load of the mass member acting on the elastomer is reduced, and the time-dependent changes in the properties are mitigated due to creep of the elastomer.

According to a fourth aspect, in the vibration damping device unit according to the third aspect, in the metal coil spring, winding diameters at two end portions in a coil axial direction are greater than a winding diameter of a central portion.

According to the vibration damping device unit configured in accordance with the aspect, by having the end portions in the coil axial direction with a large coil diameter overlapped with the mass member and the support base, when the compressive force acts on the metal coil spring, the metal coil spring is difficult to tilt due to high vertical stability, and since the mass member is stably supported by the metal coil spring, undesired vibrations of the mass member (horizontal vibration, rotation, etc.) can be suppressed. Also, compared to the case where the coil diameter is enlarged throughout the entire metal coil spring, the elastomer adhered to the metal coil spring has a small diameter, allowing the spring constant of the linking member to be small to realize soft spring properties.

According to a fifth aspect, in the vibration damping device unit according to the third or fourth aspect, mounting flange members are provided at two end portions of the linking member in the vertical direction, the mounting flange members having bolt fixing parts respectively provided to the mass member and the support base, and the elastomer forming the linking member is adhered to the mounting flange member.

According to the vibration damping device unit configured in accordance with the aspect,

by having the mounting flange members provided at both vertical end portions of the linking member bolt-fixed to one of the mass member and the support base, the vertical end portions of the linking member can be stably attached to the mass member and the support base. Also, by having the elastomer adhered to the mounting flange members, the mounting flange member can be held in an appropriate position relative to the linking member.

According to a sixth aspect, in the vibration damping device unit according to the fifth aspect, in the mounting flange member provided at at least one end of the linking member, the bolt fixing part with respect to the mass member or the support base is arranged to be able to adjust a fixed position around an elastic central axis extending in the vertical direction in the linking member.

According to the vibration damping device unit configured in accordance with the aspect, by enabling the adjustment of the fixed position of the bolt fixing part with respect to the mass member or the support base, positional deviation of the bolt fixing part relative to the mass member or the support base is accommodated around the vertical elastic central axis of the linking member, thereby preventing improper attachment of the linking member to the mass member or the support base. In addition, for example, in the case where the mounting flange members provided at both ends of the linking member are deviated in the circumferential direction around the elastic central axis of the linking member with respect to the mass member or the support base, when the mounting flange members are fixed to the mass member and the support base while torsional stress is applied to the linking member, there is a risk of affecting the durability and spring properties of the linking member. However, by making the fixed position of the bolt fixing part adjustable in the circumferential direction, unintended torsional stress acting on the linking member can be prevented.

According to a seventh aspect, in the vibration damping device unit according to any one of the first to sixth aspects, each of the mass members is elastically linked to the support base by the linking members attached in parallel.

According to the vibration damping device unit configured in accordance with the aspect, compared to the case where the mass member is elastically linked to the support base by using only one linking member, the support configuration of the mass member is stabilized, preventing unintended swinging of the mass member during vibration input, for example. Also, since the mass member is shared and supported by using multiple linking members, the support load input to each linking member is reduced, and the creep of the elastic material is reduced.

According to an eighth aspect, in the vibration damping device unit according to any one

of the first to seventh aspects, the mass members are arranged to have masses same as each other, and spring properties of the linking member elastically supporting the mass members on the support base are different among the mass members, thereby forming the auxiliary vibration systems whose natural frequencies in the vertical direction are different from each other.

According to the vibration damping device unit configured in accordance with the aspect, for example, while adopting common mass members, by using the linking members with different spring properties, multiple auxiliary vibration systems with natural frequencies in the vertical direction that are different from each other can be formed.

According to a ninth aspect, in the vibration damping device unit according to the eighth aspect, the linking member is selectable from multiple types prepared with spring properties different from each other, and with the linking members of same spring properties being attached to each of the mass members, the respective mass members are elastically supported on the support base in a state in which each of the mass members is evenly supported in terms of mass by the linking members.

According to the vibration damping device unit configured in accordance with the aspect, by selecting the linking member according to the required properties from multiple types of linking members prepared with different spring properties from each other, the vibration damping device corresponding to the required properties can be selectively configured. Also, since one mass member is supported by multiple linking members, stable support of the mass member by the linking members is realized. Furthermore, since the multiple linking members supporting one mass member have the same spring properties, the support load of the mass member is distributed without being concentrated on a specific linking member, and the durability of the linking members is improved and the support of the mass member is stabilized.

According to a tenth aspect, the vibration damping device unit according to any one of the first to ninth aspects includes a lateral vibration limiting mechanism that allows relative displacement of the mass member in the vertical direction with respect to the support base and limits a relative displacement amount of the mass member in a horizontal direction with respect to the support base.

According to the vibration damping device unit configured in accordance with the aspect, while effectively obtaining the intended vibration damping performance in the vertical direction, unintended displacement of the mass member in the horizontal direction is suppressed by the lateral vibration limiting mechanism, thereby saving the space in the installation space by avoiding interference with the surroundings of the mass member, and improving the durability of the linking members.

The eleventh aspect is a vibration damping device for vibration in a vertical direction for a building structure. A linking member elastically supporting a mass member is formed by using a composite structure in which an elastomer is adhered to a spring wire of a metal coil spring to cover an entire surface of the spring wire. The elastomer is arranged as a hollow structure having a central hole extending in a spring central axis direction of the metal coil spring.

According to the vibration damping device configured in accordance with the aspect, a large adhesion area between the surface of the spring wire of the metal coil spring and the elastomer is secured, and the adhesion strength between the spring wire and the elastomer is increased. Therefore, the elastomer is prevented from being peeled off from the metal coil spring, effectively causing the elastomer to deform in accordance with the metal coil spring, and effectively obtaining the damping effect of the elastomer.

By having the elastomer arranged to elastically link adjacent spring wires in the spring axial direction of the metal coil spring, local bending deformation of the elastomer is prevented during the compression deformation of the metal coil spring. In addition, since the elastomer has high deformation conformability to the deformation of the metal coil spring, the damping effect of the elastomer can be efficiently exhibited. Additionally, since the mass member is directly supported by both the metal coil spring and the elastomer, the shared support load of the mass member acting on the elastomer is reduced, and the time-dependent changes in the properties are mitigated due to creep of the elastomer.

According to a twelfth aspect, in the vibration damping device according to the eleventh aspect, a spiral uneven portion is provided on at least one of an inner circumferential surface and an outer circumferential surface of the elastomer, the spiral uneven portion extending in a winding direction of the spring wire of the metal coil spring.

According to the vibration damping device configured in accordance with the aspect, the free surface area of the elastomer is increased by the uneven portion, and properties such as spring properties and damping properties can be adjusted. Moreover, since the uneven portion is formed in a spiral shape extending in the winding direction of the spring wire of the metal coil spring, the uneven portion has little effect on the extension and contraction deformation of the metal coil spring.

According to a thirteenth aspect, in the vibration damping device according to the eleventh or twelfth aspect, a groove-shaped cutout part is provided on the elastomer, the cutout part being open on the inner circumferential surface or the outer circumferential surface and between adjacent pitches of the spring wire in the vertical direction in the metal coil spring.

According to the vibration damping device configured in accordance with the aspect, since the cutout part is provided in the elastomer between the pitches of the spring wire, there are fewer portions of the elastomer that are compressed between the spring wires during vertical vibration input. Therefore, it is possible to prevent the spring constant of the linking member from increasing due to the compression spring of the elastomer, making it possible to tune the spring properties of the linking member to be softer.

It should be noted that for the vibration damping devices described in the eleventh to thirteenth embodiments, it is also possible to arbitrarily and suitably apply each corresponding structure of the linking member described in any one of the fourth to sixth embodiments.

According to the disclosure, it is possible to provide a vibration damping device unit that can efficiently exert a vibration damping effect against vertical vibrations that are problematic for a building structure, as well as a vibration damping device that is suitably used in such a vibration damping device unit.

The embodiments of the disclosure will be described below with reference to the drawings.

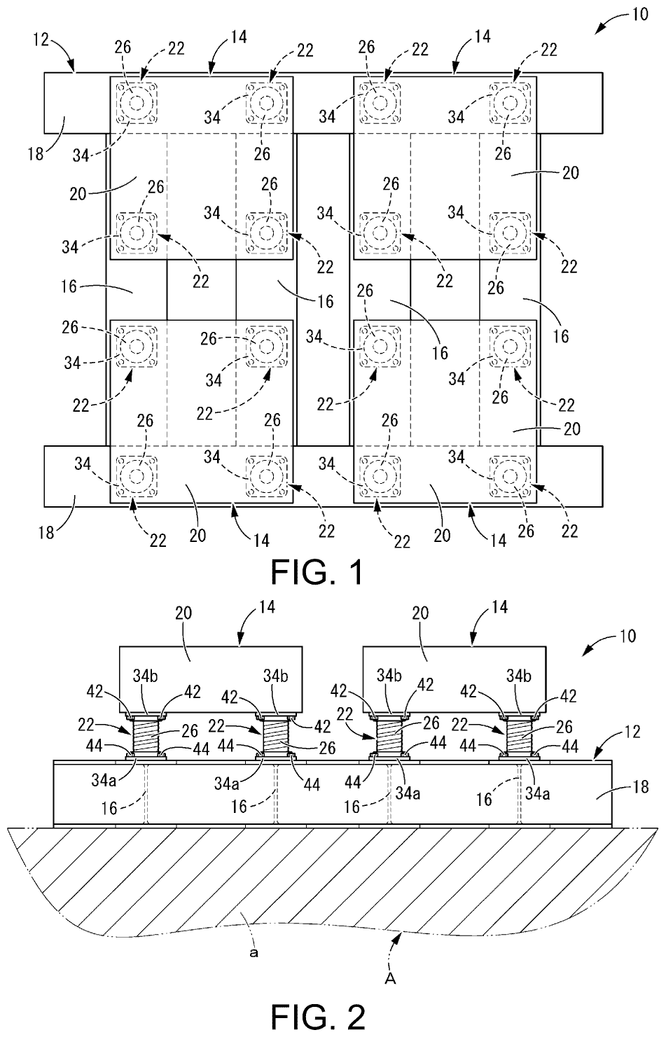

FIG. 1 and FIG. 2 show a vibration damping device unit 10 as a first embodiment of the disclosure. The vibration damping device unit 10 has a structure in which multiple vibration damping devices 14 are attached to a support base 12. In the following description, in principle, the upper-lower direction refers to the vertical, upper-lower direction of a building structure A, which is the upper-lower direction in FIG. 2. The front-rear direction refers to the upper-lower direction in FIG. 1. In addition, the left-right direction refers to the left-right direction in FIG. 1.

As shown in FIG. 1, the support base 12 has a structure in which four first beam members 16, 16, 16, 16 extending in the front-rear direction are arranged to span between two second beam members 18, 18 extending in the left-right direction. Both the first beam members 16 and the second beam members 18 extend linearly and are made of a high-rigidity steel material. In the embodiment, the first beam members 16 and the second beam members 18 are H-shaped steels. The four first beam members 16, 16, 16, 16 are arranged in parallel and separated from each other in the left-right direction. The two second beam members 18, 18 are arranged in parallel and separated from each other in the front-rear direction. The support base 12 is formed by fixing both ends of each of the first beam members 16 to each of the second beam members 18, 18 by means such as welding or bolt-fixing.

The vibration damping device 14 serves to dampen the vertical vibration of the building structure A in the upper-lower direction. As shown in FIG. 1 and FIG. 2, the vibration damping device 14 has a structure in which one mass member 20 is supported by multiple linking members 22. The mass member 20 is formed in an approximately rectangular block shape and may be made of a material with a high specific gravity, such as iron. The mass member 20 has a length dimension in the left-right direction greater than the distance between adjacent first beam members 16, 16. The mass member 20 has a length dimension in the front-rear direction that is smaller than half the distance between the two second beam members 18, 18. At the four corner portions of the mass member 20, screw holes (not shown) open on the bottom surface are formed. Four screw holes are provided at the respective corner portions of the mass member 20 and are arranged at positions corresponding to respective bolt holes 36 of a mounting flange member 34 to be described later. The mass of the mass member 20 is set by considering the mass of the building structure A that is the vibration damping target, the vibration frequency of the vibration target, the spring constant of the linking member 22 in the vertical direction, etc. In the embodiment, the entire mass member 20 is formed as a single block, but it is also possible to form the mass member 20 by stacking multiple metal plates and fixing the metal plates to each other, and the mass of the mass member 20 can be adjusted by changing the number of metal plates that are stacked.

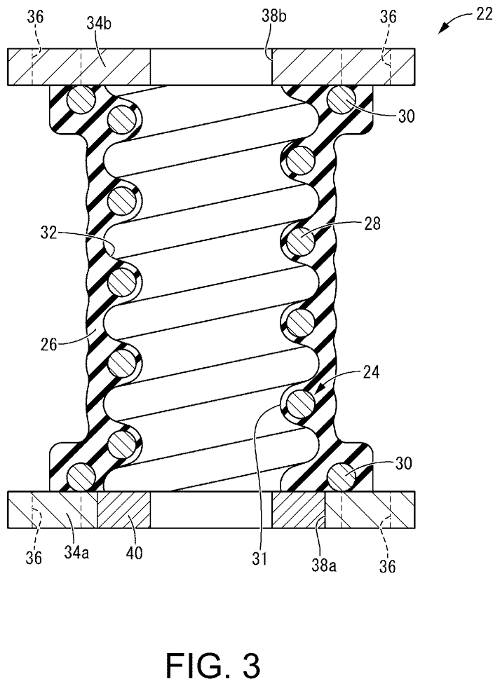

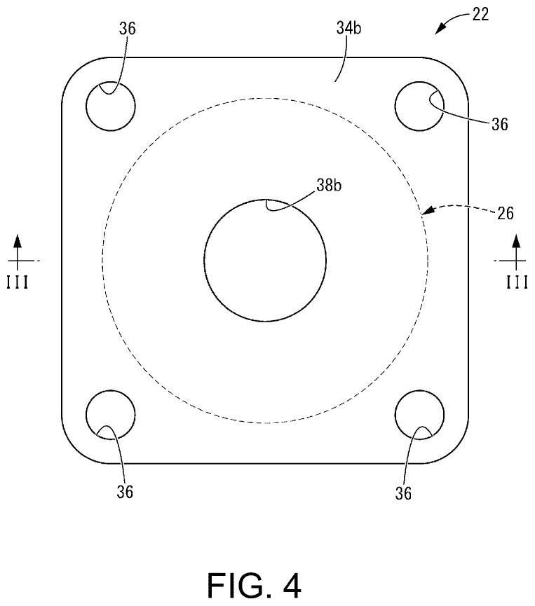

As shown in FIGS. 3 and 4, the linking member 22 is a composite structure having a structure in which an elastomer 26 as an elastic material is adhered to a metal coil spring 24 as another elastic material. The linking member 22 includes a spring element and a damping element, where the spring element is formed by the metal coil spring 24 and the elastomer 26, while the damping element is formed by the elastomer 26.

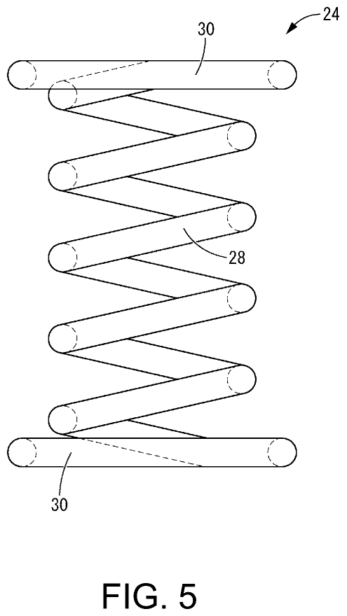

As shown in FIG. 5, the metal coil spring 24 has a structure in which a spring wire 28 formed of spring steel extends in a spiral shape. In the metal coil spring 24, both end portions of the spring wire 28 in the axial direction are formed as large diameter parts 30 with a winding diameter larger than the central portion of the spring wire 28 in the axial direction. In the embodiment, the large diameter part 30 of the spring wire 28 is provided for approximately one turn at the end of the metal coil spring 24 in the axial direction. In the metal coil spring 24 of the embodiment, the cross-sectional shape of the spring wire 28 is approximately circular and is approximately constant along the length direction of the spring wire 28. However, the spring wire 28 of the metal coil spring 24 may have a cross-sectional shape or a cross-sectional area that varies along the length direction, and the cross-sectional shape is not limited to circular. Additionally, both end portions of the metal coil spring 24 may be subjected to a grinding process, and by making the surface that overlaps with the mounting flange member 34 to be described later flat, the inclination of the metal coil spring 24 is suppressed.

The elastomer 26 is adhered to the surface of the metal coil spring 24, and as a whole, has a cylindrical hollow structure corresponding to the metal coil spring 24 and has a central hole 31 penetrating in the upper-lower direction. The elastomer 26 is adhered to cover the entire surface of the spring wire 28 of the metal coil spring 24, and the metal coil spring 24 is arranged to be embedded inside the elastomer 26. The portion of the elastomer 26 covering the outer circumferential side of the metal coil spring 24 is thicker than the portion covering the inner circumferential side. The elastomer 26 is formed of, for example, rubber or resin elastomer, and has rubber-like elasticity. The elastomer 26 may be formed of a material that provides a significant energy damping effect based on internal friction, etc., due to elastic deformation. In the embodiment, the elastomer 26 is formed of rubber. The elastomer 26 may also be formed of a material having numerous air bubbles inside, such as foam rubber.

Since the intermediate portion excluding the large diameter parts 30, 30 of the metal coil spring 24 in the upper-lower direction has a diameter smaller than the large diameter parts 30, 30, the intermediate portion of the elastomer 26 adhered to the metal coil spring 24 in the upper-lower direction has a smaller diameter. As a result, compared to a case where the entirety in the upper-lower direction is arranged with a large diameter corresponding to the adhesion portion to the large diameter part 30, the spring constant of the elastomer 26 in the upper-lower direction is reduced, and it is possible to set to the linking member 22 a low spring property in the upper-lower direction.

The elastomer 26 includes groove-shaped cutout parts 32 open on the inner circumferential surface between the pitches of the spring wire 28 of the metal coil spring 24. The cutout part 32 extends spirally along the winding direction of the spring wire 28 of the metal coil spring 24. With the cutout parts 32 being formed, the elastomer 26 is thinned in the radial direction between the pitches of the spring wire 28, and the compression spring constant is reduced in the upper-lower direction, which is the axial direction. The deepest part of the cutout part 32 is positioned on the outer circumference with respect to the axial central portion, excluding the large diameter part 30 of the metal coil spring 24. In other words, the space between adjacent spring wires 28 in the coil axial direction of the metal coil spring 24 is not continuously filled with the elastomer 26 in the axial direction.

In the embodiment, a spirally extending uneven portion is formed by the cutout parts 32 on the inner circumferential surface of the elastomer 26. However, instead of or in addition to such uneven portion on the inner circumferential surface, a spirally extending uneven portion may also be formed on the outer circumferential surface of the elastomer 26. In the embodiment, the outer circumferential surface of the elastomer 26 has slight unevenness and protrudes toward the outer circumference between the pitches of the spring wire 28. However, the outer circumferential surface of the elastomer 26 is formed in an approximately cylindrical shape as a whole. That is, in the embodiment, on both the inner circumferential surface and the outer circumferential surface of the elastomer 26, curved uneven portions that protrude outward are provided between adjacent spring wires 28 in the spring axial direction.

In the embodiment, the depth (the deepest position in the coil radial direction) of the cutout part 32 is made approximately the same as the winding outer diameter of the metal coil spring 24. However, the depth of the cutout parts 32 is not limited, and may be smaller than the winding inner diameter of the metal coil spring 24 or greater than the winding outer diameter, for example. However, the depth of the cutout part 32 may be formed by being made larger than the winding inner diameter to hollow out between adjacent windings in the coil axial direction. As will be described later, in the case where the cutout part that is open on the outer circumferential surface of the elastomer 26, similarly, the depth of such cutout part is not limited. However, the depth of the cutout part may be formed by being suitably made smaller than the coil outer diameter to hollow out between adjacent windings in the coil axial direction.

In the metal coil spring 24, the pitches of adjacent spring wires 28 in the upper-lower direction are linked by the elastomer 26. In the embodiment, with the formation of the cutout part 32, the pitches of the spring wire 28 are linked by the elastomer 26 on the outer circumferential side of the spring wire 28.

Mounting flange members 34a, 34b are fixed to both ends of the elastomer 26 in the axial direction. The mounting flange member 34 is formed in an approximately rectangular plate shape with rounded corners, and in a top-down view, the mounting flange member 34 is formed in an approximately square shape with the length of each side greater than the winding diameter of the large diameter part 30 of the metal coil spring 24.

The bolt holes 36 as bolt fixing parts that penetrate in the upper-lower direction are respectively formed at the four corners of the mounting flange member 34. In the embodiment, the bolt hole 36 is formed as a circular hole. The four bolt holes 36, 36, 36, 36 are positioned on a virtual circle concentric with respect to the metal coil spring 24, and are in equal distances from the central axis of the metal coil spring 24. Also, the four bolt holes 36, 36, 36, 36 are positioned on the diagonals of the mounting flange member 34, and the intersection of the diagonals of the mounting flange member 34 is positioned on the central axis of the metal coil spring 24.

A circular through hole 38 that penetrates in the upper-lower direction is formed in the central portion of the mounting flange member 34. The through hole 38a of one mounting flange member 34a is made larger in diameter than the through hole 38b of the other mounting flange member 34b, and a ring-shaped metal fitting 40, which is separate from the mounting flange member 34a, is press-fitted and fixed into the through hole 38a.

The elastomer 26 with the metal coil spring 24 arranged inside has both ends in the axial direction adhered to the mounting flange members 34a, 34b. The elastomer 26 is vulcanization-bonded to the mounting flange members 34a, 34b at the outer circumference with respect to the through holes 38a, 38b. Since the ends of the elastomer 26 in the axial direction, which are made larger in diameter and fixed to the large diameter parts 30 of the metal coil spring 24, are fixed to the mounting flange members 34, the adhesion strength is reinforced. The bolt holes 36 provided at the respective corner portions of the mounting flange members 34a, 34b are all positioned on the outer circumference with respect to the elastomer 26 and are exposed without being covered by the elastomer 26.

The metal coil spring 24 and the mounting flange members 34a, 34b may be overlapped in a direct contact state. However, with the metal coil spring 24 and the mounting flange members 34a, 34b being overlapped via the elastomer 26, rattling and other issues are more easily prevented. In particular, since the large diameter part 30 of the metal coil spring 24 is overlapped with the mounting flange member 34 via the elastomer 26, unintended tilting of the metal coil spring 24 is less likely to occur. The elastomer 26 interposed between the overlapping surfaces of the metal coil spring 24 and the mounting flange member 34 is made sufficiently thin, and the length dimension of the metal coil spring 24 in the upper-lower direction is made approximately the same as the length dimension of the elastomer 26 in the upper-lower direction. Both the length dimensions of the metal coil spring 24 and the elastomer 26 in the upper-lower direction are sized to be able to mutually link the mounting flange members 34a, 34b in the upper-lower direction. Also, with the elastomer 26 interposed between the overlapping surfaces of the metal coil spring 24 and the mounting flange member 34 being made sufficiently thin, there is almost no influence on the properties such as spring properties or damping properties due to the elastomer 26 between the overlapping surfaces, and the properties are approximately the same as those in the state where the metal coil spring 24 and the mounting flange member 34 are directly overlapped. Therefore, the metal coil spring 24 and the mounting flange member 34 can be considered as being directly linked.

An inner mold (not shown) that molds the inner circumferential surface of the elastomer 26 is removed through the through hole 38a of the mounting flange member 34a after vulcanization molding of the elastomer 26. Then, after the inner mold is removed, the ring-shaped metal fitting 40 is fixed to the through hole 38a. Therefore, the inner circumferential edge (opening edge of the through hole 38a) of the mounting flange member 34a is positioned on the outer circumference with respect to the deepest part (outermost circumferential end) of the cutout part 32 in the elastomer 26.

The linking member 22 is attached to the mass member 20 as shown in FIG. 1 and FIG. 2. Specifically, the upper end of the linking member 22 is fixed to the mass member 20 by screwing bolts 42 inserted through the bolt holes 36 of the mounting flange member 34b into threaded holes (not shown) open on the lower surface of the mass member 20. Four linking members 22, 22, 22, 22 are attached in parallel to the four corner portions in one mass member 20. Accordingly, the vibration damping device 14 in which the four corner portions of the mass member 20 are elastically supported by the four linking members 22, 22, 22, 22 is formed.

The four linking members 22, 22, 22, 22 forming one vibration damping device 14 may have the same spring properties as each other. Also, the four linking members 22, 22, 22, 22 may be common components with shapes, sizes, structures, and material properties being made identical. As a result, the mass of the mass member 20 is evenly supported by the four linking members 22, 22, 22, 22. Therefore, it is possible to prevent an issue such as the support load of the mass member 20 acting intensively on a specific linking member 22, or the mass member 20 swinging unintentionally during vibration input. For example, it is also possible to select the linking members 22 with spring properties as required from multiple types of linking members 22 with different spring properties prepared in advance, and attach the four linking members 22, 22, 22, 22 with the same selected spring properties to one mass member 20.

The vibration damping device 14 forms an auxiliary vibration system by being attached to the support base 12. Specifically, the lower end of each linking member 22 forming the vibration damping device 14 is fixed to the support base 12 by inserting the bolt 44 inserted through the bolt hole 36 of the mounting flange member 34a through a bolt hole (not shown) of the support base 12 and screwing the bolt 44 into a nut (not shown). Among the four linking members 22, 22, 22, 22 attached to the mass member 20, two of the linking members 22, 22, 22, 22 are attached to the respective first beam members 16, 16, and the other two are attached to the second beam member 18. The mass member 20 is directly and elastically supported relative to the support base 12 by using both the metal coil spring 24 and the elastomer 26 forming the linking member 22. In short, the metal coil spring 24 and the elastomer 26 in the linking member 22 are arranged in parallel in the upper-lower direction, which is the support direction of the mass member 20, and each of the metal coil spring 24 and the elastomer 26 links the mass member 20 to the support base 12.

In the embodiment, four vibration damping devices 14, 14, 14, 14 are attached to the support base 12, separated from each other in the front-rear direction and the left-right direction. The vibration damping device unit 10 is formed as a tuned mass damper (TMD) having four auxiliary vibration systems. By attaching four vibration damping devices 14, 14, 14, 14 to the support base 12, it is possible to secure a sufficient total mass for the entire vibration damping device unit 10 while reducing the mass of the mass member 20 of each vibration damping device 14. Therefore, the attachment process of the vibration damping device 14 to the support base 12 becomes easier, and the manufacturing, storage, and transportation, etc., of the vibration damping device 14 also become easier.

As shown in FIG. 2, the vibration damping device unit 10 having such a structure is mounted to a building structure A by fixedly attaching the support base 12 to a structural material a, such as a floor structural material, forming the building structure A as the main vibration system. The method of attaching the support base 12 to the structural material a is not particularly limited, but for example, the support base 12 may be attached by being fixed to the structural material a by using a bolt or through welding.

Since multiple vibration damping devices 14 are integrated into a unit structure by using the support base 12, it becomes possible to directly exert the vibration damping effect on the structural material a through the vibration damping devices 14 by linking the support base 12 to the structural material a where vibration increases due to, for example, the resonance phenomena.

In addition, by appropriately setting the shape and the size of the support base 12, it becomes possible to set an installation space for the mass member 20, etc., at a position away from the structural material a, which is the vibration damping target, thereby improving design flexibility. Furthermore, since multiple vibration damping devices 14 are stably supported by the support base 12, the vibration damping devices 14 can be stably mounted to the structural material a in a horizontal state regardless of the shape or structure of the mounting portion of the vibration damping device unit 10 in the structural material a.

When the vibration in the upper-lower direction is applied to the structural material a to which the vibration damping device unit 10 is attached, the vibration in the upper-lower direction input from the structural material a to the support base 12 is transmitted to the mass member 20 through the linking member 22, and the mass member 20 is displaced in the upper-lower direction. Then, the kinetic energy of the mass member 20 converted from the vibration energy of the vibration of the vibration damping target is absorbed by the energy damping effect of the elastomer 26 forming the linking member 22. In this way, the vertical (upper-lower direction) vibration of the structural material a, which is the vibration damping target, and consequently the building structure A is reduced by a dynamic vibration absorbing effect of the auxiliary vibration system (vibration damping device 14) forming the vibration damping device unit 10.

Each vibration damping device 14 exhibits an excellent vibration damping effect through the dynamic vibration absorbing action, as the mass member 20 actively displaces in a resonant state during the input of the vibration at a tuning frequency set in advance by the mass of the mass member 20 and the spring constant of the linking member 22. On the other hand, for input vibrations at a frequency deviated from the tuning frequency, the displacement of the mass member 20 becomes smaller, and an effective vibration damping effect may not be exhibited. Therefore, the four vibration damping devices 14, 14, 14, 14 forming the vibration damping device unit 10 have natural frequencies (resonance frequencies of the mass-spring system) in the upper-lower direction that differ from each other. As a result, the four vibration damping devices 14, 14, 14, 14 exhibit a vibration damping effect against multiple types of vibrations whose frequencies are different from each other, and the vibration damping device unit 10 as a TMD with vibration damping performance for input vibrations in a wider frequency domain is realized.

As a means with the natural frequencies of the four vibration damping devices 14, 14, 14, 14 different from each other, while the masses of the mass members 20 of each vibration damping device 14 may be made different from each other, it may also be that the spring properties of the linking members 22 of each vibration damping device 14 are different from each other. Accordingly, it becomes possible to obtain multiple types of vibration damping devices 14 with mutually different natural frequencies while standardizing large and massive mass members 20. In the embodiment, the masses of the four mass members 20, 20, 20, 20 are the same, while the spring properties of the linking members 22 of the respective vibration damping devices 14 in the upper-lower direction are different from each other, and different natural frequencies in the upper-lower direction are set in the four vibration damping devices 14, 14, 14, 14. The natural frequency of each vibration damping device 14 is appropriately set according to the vibration state (e.g., the frequency of the vibration of the vibration damping target, etc.) of the building structure A, which is the vibration damping target. However, for example, it is set to exhibit an effective vibration damping effect with respect to vibrations of 3 Hz to 30 Hz that tend to be problematic for the building structure A.

It should be noted that in the case of making the natural frequencies of the four vibration damping devices 14, 14, 14, 14 different, it is not necessarily required that the natural frequencies of all four vibration damping devices 14, 14, 14, 14 be different. For example, the four vibration damping devices 14, 14, 14, 14 may be tuned to have the same natural frequency in pairs, with the natural frequencies being different between two of the vibration damping devices 14, 14 and the other two vibration damping devices 14, 14.

The linking member 22 of the vibration damping device 14 has a structure in which the elastomer 26 is adhered to the entire surface of the metal coil spring 24, and is a novel structure that integrally includes spring elements and damping elements not provided in conventional vibration damping devices for building structures. According to such linking member 22, compared to the conventional vibration damping device where a spring element and a damping element (damper) are provided separately, the structure becomes simple and can be provided in a narrower installation space. In addition, by adjusting the resonance frequency of the mass-spring system (auxiliary vibration system), which uses the linking member 22 as a spring, according to the natural frequency of the building structure A as the main vibration system, vibrations in the resonance frequency domain of the main vibration system can be efficiently reduced by the auxiliary vibration system. Since the linking member 22 is a composite structure that has the metal coil spring 24 and the elastomer 26 in parallel (rather than in series) between the main vibration system and the auxiliary vibration system, the resonance frequency of the auxiliary vibration system can be adjusted not only by the spring properties of the metal coil spring 24 but also by the spring properties of the elastomer 26, and it is possible to obtain a greater flexibility for tuning the resonance frequency.

The elastomer 26 adhered to the entire surface of the metal coil spring 24 deforms

following the expansion and contraction deformation of the metal coil spring 24 in the upper-lower direction, and since it is unlikely to generate bending deformation, the targeted properties such as damping and spring properties can be obtained efficiently and stably.

In addition, since the load input from the mass member 20 to the linking member 22 is shared and supported by the metal coil spring 24 and the elastomer 26, the input of the load to the elastomer 26 is reduced. Accordingly, changes in properties due to creep of the elastomer 26 are prevented, and the damage due to excessive deformation of the elastomer 26 is prevented.

In addition, since the elastomer 26 is adhered to the entire surface of the metal coil spring 24, the adhesion area of the elastomer 26 to the metal coil spring 24 is increased, the adhesion strength is increased, and the elastomer 26 is prevented from peeling off from the metal coil spring 24.

Furthermore, since the elastomer 26 is adhered to the entire surface of the metal coil spring 24, it can be expected to achieve low spring properties and further reduction of creep. Specifically, since the metal coil spring 24 undergoes torsional deformation around the central axis of the spring wire 28 during elastic deformation in the spring axial direction, the elastomer 26 adhered to the surface of the metal coil spring 24 also undergoes elastic deformation that twists along the surface of the spring wire 28. Since such elastic deformation involves shear deformation, compared to an elastomer that simply undergoes compression deformation in the opposing direction between the support base 12 of the vibration damping device unit 10 and the structural material a of the building structure A, it can be expected to increase the damping component while avoiding a significant increase in spring stiffness. In particular, since the elastomer 26 is adhered to cover the entire surface of the metal coil spring 24, compared to a case where the elastomer is adhered to only a portion of the surface of the metal coil spring 24, the torsional deformation of the spring wire 28 can be easily and efficiently transmitted to the elastomer 26 as elastic deformation including a shear component. Furthermore, as in this embodiment, by providing the cut part 32 in the elastomer 26, or by arranging a curved uneven shape to the outer circumference between the pitches of the metal coil spring 24, it can be expected to stabilize the curved shape during compression deformation in the spring axial direction, as well as to improve the efficiency of the manifestation of deformation modes including shear components, and to further enhance the compatibility of low spring properties and high damping in the elastomer 26.

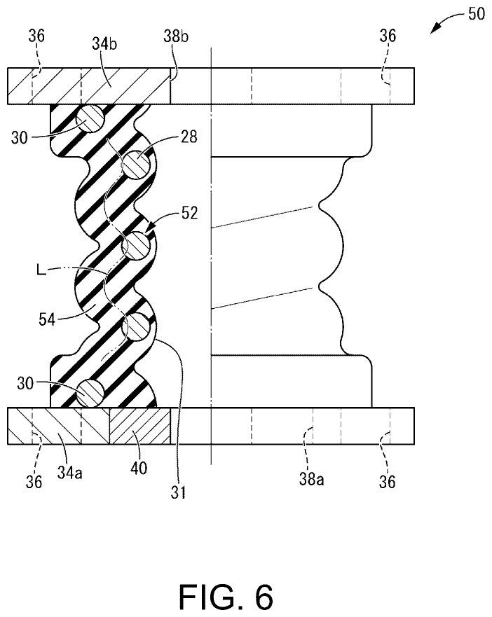

FIG. 6 shows a linking member 50 of a vibration damping device forming a vibration damping device unit as a second embodiment of the disclosure. The linking member 50 has a structure in which an elastomer 54 as another elastic material is adhered to a metal coil spring 52 as an elastic material. In the following description, for components and parts that are substantially identical to those in the first embodiment, the description will be omitted by assigning the same reference numerals in the figure. In the linking member 50 shown in FIG. 6, with respect to the center in the left-right direction as indicated by a dot-chain line in the figure, the right side is a front view and the left side is a vertical cross-sectional view. The linking member 50 of the embodiment, like the linking member 22 of the first embodiment, elastically links a mass member and a support base (not shown) to form a vibration damping device.

The metal coil spring 52, compared to the metal coil spring 24 of the first embodiment, has a smaller difference between the length dimension in the upper-lower direction and the outer diameter dimension. Additionally, the metal coil spring 52 has fewer windings of the spring wire 28 than the metal coil spring 24 of the first embodiment.

The elastomer 54 has a substantially cylindrical hollow structure and is adhered to the entire surface of the spring wire 28 forming the metal coil spring 52. The inner circumferential surface of the elastomer 54 has a wave-shaped uneven portion. The outer circumferential surface of the intermediate portion of the elastomer 54 in the upper-lower direction has an uneven portion corresponding to the inner circumferential surface. Accordingly, a cross-section central line L extending in the upper-lower direction of the elastomer 54 has a wave shape that protrudes toward the outer circumference between the pitches of adjacent spring wires 28 in the upper-lower direction, and protrudes toward the inner circumference at the adhesion portions of the spring wire 28. In the spring wire 28 of the metal coil spring 52, the middle portion excluding the large diameter part 30 with an increased winding diameter is adhered to the inside of the elastomer 54 between the radial space between the protrusion of the inner circumferential surface and the recess of the outer circumferential surface of the elastomer 54. In other words, the protrusion of the inner circumferential surface of the elastomer 54 is positioned at the inner circumference of the spring wire 28 of the metal coil spring 52, and the recess of the outer circumferential surface of the elastomer 54 is positioned at the outer circumference of the spring wire 28. The uneven portions of the inner and outer circumferential surfaces of the elastomer 54 extend spirally along the spring wire 28 of the metal coil spring 52. The elastomer 54 is arranged at a position overlapped with the spring wire 28 (excluding the large diameter part 30) in the projection of the upper-lower direction, and at the time of the compression of the metal coil spring 52, a portion of the elastomer 54 is directly compressed in the axial direction between adjacent spring wires 28 in the upper-lower direction.

In the embodiment, the linking member 50 has uneven portions provided on the inner circumferential surface and the outer circumferential surface of the elastomer 54, respectively, and the spring wire 28 of the metal coil spring 52 is adhered between the protrusion of the inner circumferential surface and the recess of the outer circumferential surface of the elastomer 54 in the radial direction. Therefore, in the portion of the elastomer 54 positioned between the pitches of adjacent spring wires 28 in the coil axial direction, the cross-section central line L is curved to protrude toward the outer circumference. Therefore, for example, in the case where the metal coil spring 52 contracts in the upper-lower direction and the pitch between adjacent spring wire 28 becomes smaller, the elastomer 54 positioned in the pitch between adjacent spring wires 28 easily deforms to bulge toward the outer circumference. Accordingly, the compression spring component in the upper-lower direction is reduced. Although the elastomer 54 has an overall substantially cylindrical shape, in the portion adhered to the spring wire 28 of the metal coil spring 52, the radial expansion deformation is suppressed by the metal coil spring 52 even during the compression deformation of the linking member 50, and the portion positioned between adjacent spring wires 28 (between pitches) in the axial direction elastically deforms to bulge outward. Accordingly, the compression deformation decreases and the shear deformation increases, and the local bending deformation is avoided.

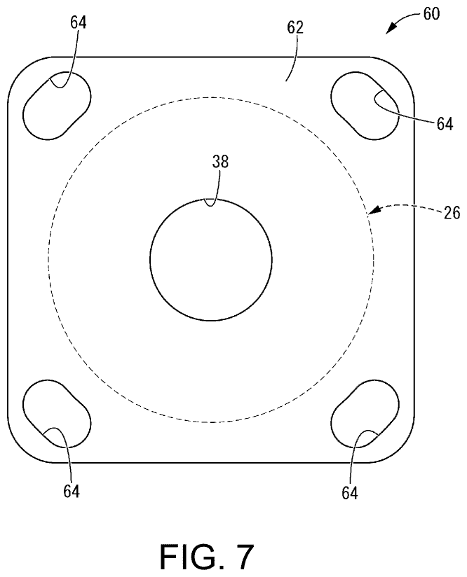

FIG. 7 shows a linking member 60 of a vibration damping device forming a vibration damping device unit as a third embodiment of the disclosure. The linking member 60 has a structure in which mounting flange members 62 are respectively adhered to upper and lower ends of the elastomer 26.

The mounting flange member 62 is formed in a substantially rectangular plate shape, and bolt holes 64 serving as bolt fixing parts are formed in the respective four corner portions. In the embodiment, the bolt holes 64 penetrate through the mounting flange member 62 in the upper-lower direction and are formed as elongated holes extending in the circumferential direction of the elastomer 26. Accordingly, during bolt fixing of the mounting flange member 62 to the mass member or support base not shown herein, it is possible to adjust the relative positions of the bolt holes 64 with respect to the mass member or support base, that is, the orientation of the vibration damping device, in the circumferential direction around the elastic central axis of the elastomer 26 extending in the vertical direction.

By making the mounting orientation of the mounting flange member 62 relative to the support base adjustable in the circumferential direction, it is possible to prevent the torsional stress from acting on the elastomer 26 due to an orientation error of the upper and lower mounting flange members 62, 62 in the circumferential direction. Accordingly, for example, in the case of molding the elastomer 26 in the state where the metal coil spring 24 and the mounting flange members 62, 62 are set in the molding cavity of the elastomer 26, it is possible to bolt-fix the upper and lower mounting flange members 62, 62 respectively to the mass member and the support base of the vibration damping device unit while avoiding the generation of the initial stress on the metal coil spring 24 and the elastomer 26, even when the upper and lower mounting flange members 62, 62 are relatively misaligned around the central axis due to molding shrinkage of the elastomer 26, etc.

In the case where the circular bolt hole 36 is adopted as a bolt fixing part, as in the mounting flange member 34 of the vibration damping device 14 of the first embodiment, for example, it is possible to enable the adjustment of the orientation or mounting position of the vibration damping device 14 by, for example, forming the bolt hole in the mass member 20 or the support base 12 as an elongated hole.

While the embodiments of the disclosure have been described in detail, the disclosure is not limited by the specific descriptions. For example, in the embodiments, the mass members 20 are common, but it is also possible to make the mass, shape, size, specific gravity (material property), etc., of multiple mass members different from each other. In the case where the masses of the mass members are different from each other, vibration damping devices with mutually different natural frequencies can be constructed even if the spring constants of the linking members supporting the respective mass member are the same. The mass member may be made of metal with high specific gravity to secure the necessary mass while preventing excessive enlargement. However, the mass member is not limited to being made of metal.

The multiple elastic materials forming the linking member 22 are not necessarily limited to the metal coil spring 24 and the elastomer 26. Also, the linking member can be constructed by combining three or more different elastic materials. For example, as an embodiment, it is possible to additionally adopt a metal coil spring without elastomer at a different position independently from the linking member 22 in the embodiments, or to additionally arrange the metal coil spring in an accommodated state inside the hollow interior of the linking member 22.

In the first embodiment, the concave cutout parts 32 that are open on the inner circumferential surface are formed in the elastomer 26 between the pitches of the spring wire 28 of the metal coil spring 24. However, for example, it is also possible to form cutout parts that are open on the outer circumferential surface of the elastomer 26 between the pitches of the spring wire 28. By adopting the cutout parts that are open on the outer circumferential surface of the elastomer, it is also possible to demold more easily during molding by making the inner circumferential surface of the elastomer an approximately straight cylindrical surface extending with an approximately constant inner diameter dimension. Also, it is possible to respectively provide cutout parts that are open on the inner circumferential surface of the elastomer 26 and cutout parts that are open on the outer circumferential surface of the elastomer 26 between the pitches of the spring wire 28. In such case, the cutout parts that are open on the inner circumferential surface of the elastomer 26 and the cutout parts that are open on the outer circumferential surface of the elastomer 26 may be provided between the same pitches in the upper-lower direction, or may be provided between different pitches. The cutout parts are not required and can be omitted. Also, the cutout parts do not necessarily have to extend spirally between the pitches of the spring wire 28. For example, the cutout parts may be provided intermittently in the winding direction of the spring wire 28, or may be provided as spots at multiple locations.

In the second embodiment, an example is shown where uneven portions are provided on both the inner circumferential surface and the outer circumferential surface of the elastomer 26, but the uneven portions may be provided on only one of the inner circumferential surface and the outer circumferential surface of the elastomer 26. Also, it is not necessarily required that the uneven portions are both concave and convex, and may be only concave or convex. For example, it may also be that concave or convex portions are provided on both the inner circumferential surface and the outer circumferential surface. By setting uneven portions in the axial direction on the inner circumferential surface and/or the outer circumferential surface of the elastomer 26, it is possible to define the deformation state of the elastomer 26 at the time of compression and deformation to actively bend and deform, and it can be expected to suppress the bending deformation due to compression deformation. For such purpose, one uneven portion may be formed on the inner circumferential surface or the outer circumferential surface to span between adjacent spring wires 28 of the metal coil spring 52 in the axial direction. However, multiple uneven portions may be formed to continue on the inner circumferential surface or the outer circumferential surface between adjacent spring wires 28 of the metal coil spring 52 in the axial direction.

The number of vibration damping devices 14 forming the vibration damping device unit 10 is not particularly limited as long as there are vibration damping devices 14. The number may be two or three, or may be five or more. Also, in the vibration damping device 14, the number of linking members 22 supporting one mass member 20 is merely exemplary, and may be three or less, or may be five or more. However, to stabilize the support of the mass member 20, one mass member 20 may be supported by three or more linking members 22. The mass of one mass member should be set in consideration of the number of masses, the building structure, the target vibration, the linking member, etc., and should not be interpreted in a limiting manner. For example, in the case of four mass members as in the embodiment, it can be set to approximately 100 kg, or more (or less) than 100 kg.

The specific structure of the support base 12 should not be interpreted as being limited by the embodiment. In particular, the arrangement of the first beam members and the second beam members can be appropriately changed according to the number and the arrangement of the linking members 22 in the vibration damping device 14. Also, the support base 12 in the embodiments is designed with a light weight by being formed by the first beam members and the second beam members, but the support base is not limited to a structure combining multiple beam members, and may be, for example, plate-shaped, etc., as long as the support base can support multiple vibration damping devices 14 and can be attached to the building structure A. The beam members 16, 18 forming the support base 12 in the embodiments are not limited to H-shaped steels, and steel materials in other shapes such as a box-shaped steel can also be adopted.

For example, it is also possible to provide a lateral vibration limiting mechanism that allows relative displacement of the mass member 20 in the vertical direction with respect to the support base 12, and limits the relative displacement amount of the mass member 20 in the horizontal direction with respect to the support base 12. The lateral vibration limiting mechanism is not limited to a specific structure as long as it includes a lateral vibration limiting mechanism that allows the movement of the mass member 20 in the upper-lower direction while limiting horizontal movement. However, for example, it may be configured such that a rod-shaped member protruding from the mass member 20 toward the support base 12 is provided, and the rod-shaped member is formed by being inserted through an insertion hole penetrating the support base 12, thus limiting the displacement amount of the mass member 20 in the horizontal direction is limited by engaging the rod-shaped member and the inner circumferential surface of the insertion hole.

Furthermore, by arranging an elastic body between the opposing surfaces of the rod-shaped member and the inner circumferential surface of the insertion hole to form a bushing shape, it is also possible to obtain a spring or a damping effect, etc., from the elastic body with respect to a small input in the horizontal direction. Also, by arranging a bearing or a sliding material that allows relative displacement between the rod-shaped member and the support base 12 in the upper-lower direction but does not allow a relative displacement in the horizontal direction, between the opposing surfaces of the rod-shaped member and the inner circumferential surface of the insertion hole, it is also possible to prevent displacement of the mass member 20 in the horizontal direction. In addition, it is also possible to provide a vertical stopper mechanism that limits excessive displacement of the mass member 20 in the vertical direction.

It may also be that that the metal coil spring 24 includes large diameter parts 30 with larger coil diameters at both end portions in the coil axial direction to achieve low spring properties and stability during input. However, for example, the metal coil spring 24 may have an approximately constant coil diameter throughout the entire length. Both ends of the metal coil spring 24 may be overlapped with the mounting flange members 34 through the elastomer 26. However, for example, the ends of the metal coil spring 24 may be directly overlapped with the mounting flange member 34 and fixed by means such as welding. The specific structure of the metal coil spring 24 is not limited, and for example, pitch-variable coil springs can also be adopted, and various end shapes such as closed ends, open ends, and tangent tail ends can be selectively adopted, and hooks or raised portions can be provided at the ends for use in fixing to the mounting flange member.

The bolt fixing part of the mounting flange member 34 is not limited to bolt holes, and for example, the bolt fixing part can also be configured by using bolts implanted in the mounting flange member 34.

What is claimed is:

1. A vibration damping device unit, mounted to a building structure to reduce vibration along a vertical direction for the building structure,
wherein the vibration damping device has a support base fixedly attached to a structural material of the building structure as a main vibration system,
a plurality of mass members are each elastically linked to the support base by using a linking member comprising a spring element and a damping element, thereby forming a plurality of auxiliary vibration systems, and
a tuned mass damper (TMD) is formed, the tuned mass damper having a plurality of natural frequencies in a vertical direction resulting from the auxiliary vibration systems.

2. The vibration damping device unit as claimed in claim 1, wherein the mass member is supported by a plurality of the linking members,
each of the linking members is arranged as a composite structure in which a plurality of elastic materials of different material properties are adhered to each other,
each of the elastic materials forming the linking member has a length dimension in an upper-lower direction able to link the mass member to the support base, and
the mass member is directly and elastically supported on the support base by using the elastic materials forming the linking member.

3. The vibration damping device unit as claimed in claim 2, wherein the elastic materials forming the linking member comprise a metal coil spring and an elastomer,
the elastomer is adhered to a spring wire of the metal coil spring to cover an entire surface of the spring wire, and
in the metal coil spring, pitches of adjacent spring wires in the vertical direction are linked by the elastomer.

4. The vibration damping device unit as claimed in claim 3, wherein in the metal coil spring, winding diameters at two end portions in a coil axial direction are greater than a winding diameter of a central portion.

5. The vibration damping device unit as claimed in claim 3, wherein mounting flange members are provided at two end portions of the linking member in the vertical direction, the mounting flange members having bolt fixing parts respectively provided to the mass member and the support base, and
the elastomer forming the linking member is adhered to the mounting flange member.

6. The vibration damping device unit as claimed in claim 5, wherein in the mounting flange member provided at at least one end of the linking member, the bolt fixing part with respect to the mass member or the support base is arranged to be able to adjust a fixed position around an elastic central axis extending in the vertical direction in the linking member.

7. The vibration damping device unit as claimed in claim 1, wherein each of the mass members is elastically linked to the support base by a plurality of the linking members attached in parallel.

8. The vibration damping device unit as claimed in claim 1, wherein the mass members are arranged to have masses same as each other, and
spring properties of the linking member elastically supporting the mass members on the support base are different among the mass members, thereby forming the auxiliary vibration systems whose natural frequencies in the vertical direction are different from each other.

9. The vibration damping device unit as claimed in claim 8, wherein the linking member is selectable from a plurality of types prepared with spring properties different from each other, and
with a plurality of the linking members of same spring properties being attached to each of the mass members, the respective mass members are elastically supported on the support base in a state in which each of the mass members is evenly supported in terms of mass by the linking members.

10. The vibration damping device unit as claimed in claim 1, comprising a lateral vibration limiting mechanism that allows relative displacement of the mass member in the vertical direction with respect to the support base and limits a relative displacement amount of the mass member in a horizontal direction with respect to the support base.

11. A vibration damping device for vibration in a vertical direction for a building structure,
wherein a linking member elastically supporting a mass member is formed by using a composite structure in which an elastomer is adhered to a spring wire of a metal coil spring to cover an entire surface of the spring wire, and
the elastomer is arranged as a hollow structure having a central hole extending in a spring central axis direction of the metal coil spring.

12. The vibration damping device as claimed in claim 11, wherein a spiral uneven portion is provided on at least one of an inner circumferential surface and an outer circumferential surface of the elastomer, the spiral uneven portion extending in a winding direction of the spring wire of the metal coil spring.

13. The vibration damping device as claimed in claim 11, wherein a groove-shaped cutout part is provided on the elastomer, the cutout part being open on the inner circumferential surface or the outer circumferential surface in a pitch between adjacent spring wires in the vertical direction in the metal coil spring.
